(19) United States
(12) Patent Application Publication
(10) Pub. No.: US 2005/0165615 A1
(43) Pub. Date: Jul. 28, 2005

(54) Embedding advertisements in syndicated content

(76) Inventor: Nelson Minar, San Francisco, CA (US)

Correspondence Address: STRAUB & POKOTYLO, 620 TINTON AVENUE, BLDG. B, 2ND FLOOR, TINTON FALLS, NJ, 07724, US

(21) Appl. No.: 10/750,361

(22) Filed: Dec. 31, 2003

(51) Int. Cl. G06F 17/60

(52) U.S. Cl. 705/1

(57) ABSTRACT

Incorporating targeted ads into information in a syndicated, e.g., RSS, presentation format in an automated manner is described. Syndicated material e.g., corresponding to a news feed, search results or web logs, are combined with the output of an automated ad server. An automated ad server is used to provide keyword or content based targeted ads. The ads are incorporated directly into a syndicated feed, e.g., with individual ads becoming items within a particular channel of the feed. The resulting syndicated feed including targeted ads is supplied to the end user, e.g., as a set of search results or as a requested web log. Embedding of targeted ads into syndicated feeds and/or user response to the embedded ads is be tracked in an automated manner for billing. The automated targeting and insertion process allows ads to be kept current and timely while the original feed may be considerably older.

### FIELD OF THE INVENTION

The present invention concerns advertising and, more particularly, embedding advertisements, e.g., targeted advertisements, into information in a syndicated content format, e.g., RSS feeds such as web log entries, news articles and search results provided in an RSS format.

### BACKGROUND OF THE INVENTION

Advertising using traditional media, such as television, radio, newspapers and magazines, is well known. Recently, advertising over more interactive media has become popular. For example, as the number of people using the Internet has exploded, advertisers have come to appreciate media and services offered over the Internet as a potentially powerful way to advertise.

Advertisers have developed several strategies in an attempt to maximize the value of such advertising. In one strategy, advertisers use popular presences or means for providing interactive media or services (referred to as “Websites” in the specification without loss of generality) as conduits to reach a large audience. Using this first approach, an advertiser may place ads on the home page of the New York Times Website, or the USA Today Website, for example. Websites are often presented using HTML.

In another strategy, an advertiser may attempt to target its ads to more narrow niche audiences, thereby increasing the likelihood of a positive response by the audience. For example, an agency promoting tourism in the Costa Rican rainforest might place ads on the ecotourism-travel subdirectory of the Yahoo Website. An advertiser will normally determine such targeting manually.

Regardless of the advertising strategy, Website-based ads (also referred to as “Web ads”) are typically presented to their advertising audience in the form of “banner ads”—i.e., a rectangular box that includes graphic components. When a member of the advertising audience (referred to as a “viewer” or “user” in the specification without loss of generality) selects one of these banner ads by clicking on it, embedded hypertext links typically direct the viewer to a page on the advertiser's Website (referred to as an “ad landing page” or simply a “landing page”). This process, wherein the viewer selects an ad, is commonly referred to as a “click-through” (“Click-through” is intended to cover any user selection).

Search engines, such as Google for example, have enabled advertisers to target their ads so that they will be rendered with search results pages presented in HTML format. The targeted advertisements are selected in an automated manner so that they will be relevant, presumably, to the query that prompted the search results page. Other targeted advertising systems or those that target ads based on content (see, e.g., U.S. patent application Ser. No. 10/375,900 (incorporated herein by reference), titled “SERVING ADVERTISEMENTS BASED ON CONTENT,” filed on Feb. 26, 2003 and listing Darrell Anderson, Paul Bucheit, Alex Carobus, Claire Cui, Jeffrey A. Dean, Georges R. Harik, Deepak Jindal, and Narayanan Shivakumar as inventors) may be designed to confront similar challenges, i.e., the selection of advertisements that are relevant to the user requested information in general, and related to the current user interest in particular.

More recently, the ability to search and provide syndicated content, e.g., news feeds, web logs, etc, has been growing in importance as syndicated content has become more popular. Syndicated content, unlike web pages which are normally stored in an HTML format, are often stored and presented in what may be described as a syndicated content format. Syndicated content formats are often XML (eXtended Markup Language) based and include structured representations of content such as news articles, search results, and web log entries. Syndicated content formats are primarily intended for providing syndicated information, e.g., news headlines, weblogs, etc. in a structured format such as a list of items, with another device, e.g., a user device, usually controlling the ultimate presentation format of the items in the list. This is in contrast to HTML which usually includes a fair amount of presentation and formatting information within an HTML document such as a web page. Syndicated content formats are frequently used for purposes of aggregating information, e.g., news information from different content providers.

Generally, syndicated content formats are formats for providing a list of discrete items. A title and a link, e.g., URL, is usually included in the list for each item. In addition to the title and link, an item description is sometimes provided. The list of discrete items is sometimes known as a channel or feed. In some syndicated content formats, a channel or feed title and link may be included with the list of discrete items. A channel, e.g., feed, description is also included with the list of discrete items in some syndicated content formats.

The syntax used to define lists of items and to identify particular items in an item list can vary depending on the particular syndicated content format used. Multiple syndicated content formats exist. RSS and Atom are exemplary syndicated content formats.

RSS is a common XML-based format for presenting syndicated content. RSS, which is described by some as an acronym for Really Simple Syndication and by others as an acronym for Rich Site Summary, is a lightweight XML format designed for sharing headlines and other Web content. RSS is an XML 1.0 compliant format. RSS provides for the distribution of syndicated content in channels identified using the syntax <channel>. An RSS channel (feed) includes a channel title, a channel link, e.g., a URL to the HTML Website corresponding to the channel, and a channel description. For each channel, one or more items are also frequently included. Normally multiple items are included in a channel with each distinct item being identified by the syntax <item> which is used to mark the beginning and end of each individual item.

While being a sub-element of a channel, an item in an RSS feed often includes a title, a link, and a description. The title is generally the title of the item while the link is usually the URL of the item. The description of the item in an RSS feed s usually a synopsis of the item. Items may be, e.g., individual news headlines in the case of a syndicated news channel, or a web log entry in the case of a web log channel.

There is a need for methods and apparatus for improving the ability to select targeted ads and present targeted ads as part of syndicated feeds, e.g., RSS feeds. It is desirable from an implementation standpoint that the targeting process be automated. It is also desirable that the presentation of ads as part of syndicated feeds be capable of being tracked, and/or that the response to such ads be capable of being tracked.

### SUMMARY OF THE INVENTION

The present invention is directed to automated methods and apparatus for incorporating targeted ads into information in a syndicated, e.g., RSS, content presentation format. Syndicated material corresponding to, e.g., a news feed, search result or web log, is obtained in response to a user request, e.g., search request or request to access or retrieve all or a portion of content such as a news feed service or a web log. In addition, one or more targeted ads are obtained, e.g., from an ad server which selects and provides targeted ads in an automated manner. The targeted ads may be selected using various methods, including keyword or content-based ad selection methods.

One or more targeted ads may be incorporated directly into the syndicated content before the syndicated material is retuned to the user of the system. Thus, the responsive set of syndicated content presented to the user may include the material being sought by the user plus one or more targeted ads. Given that the targeted ad(s) is inserted in response to a request for syndicated material, as opposed to being included in the syndicated material at the time the syndicated material was generated, the ad can be kept current and timely. Thus, presentation of ads for discontinued products or services, or ads for which the company which originally placed the ad may no longer be paying can be avoided even when displaying web logs and/or news feeds which may be months or years old.

In some embodiments of the present invention targeted ads are included in a syndicated feed as an item corresponding to a channel existing in the original syndicated material. Such an embodiment is particularly well suited for RSS embodiments where a syndicated news feed or web log may include multiple items under a single channel header. In accordance with one exemplary embodiment of the present invention, the targeted ad returned by a web server is embedded into the RSS feed as an additional item in a channel which already exists in the feed. Different targeted ads may be, and in various embodiments are, inserted into different channels of an RSS feed prior to delivery to a user. Such an embodiment is particularly well suited for content-based targeted ads where the ad inserted into each channel as an additional item may be selected as a function of the description or content of the channel into which the targeted ad is inserted.

The number of inserted ads presented to a user and/or the user's response is monitored in various embodiments. The results of the monitoring may be stored in an accounting database and the advertisers may be billed according to the collected presentation and/or user response information. Ad selection and/or billing agreements/mechanisms can be updated independently of the syndicated material because in certain embodiments the targeted ads are inserted shortly prior to presentation (e.g., during the distribution of an RSS feed) as opposed to being incorporated directly into the syndicated material, e.g., news story or web log, at the time the original syndicated material is created. Thus, the automated targeting and insertion process allows ads to be kept current and timely even if the original feed is considerably older.

In some embodiments ad targeting information, such as keywords, and/or instructions that allow/cause a recipient of syndicated content to make a request for ads is incorporated into the syndicated information, e.g., at the time the news feed and/or content is originally created. In such embodiments, the keywords and/or commands are used to control the retrieval and/or incorporation of targeted ads into the syndicated content prior to presentation or distribution to one or more users.

The combining of one or more targeted ads with syndicated information to generate the feed ultimately presented to a user may be generated remotely, e.g., by a service provider system coupled to a user's system, or locally, e.g., by a user's own computer system or content-rendering device. In the case of one local feed generation implementation, a user's Web browser combines an RSS feed returned in response to a search result with at least one targeted ad returned by a targeted ad server, before presenting the RSS feed including the targeted ad to the user.

Numerous additional features, benefits and details of various embodiments of the present invention are discussed below in the detailed description which follows.

### BRIEF DESCRIPTION OF THE DRAWINGS

FIG. 1 is a block diagram showing an exemplary system implemented in accordance with the present invention.

FIG. 2 illustrates various signaling that occurs in one exemplary embodiment of the invention which uses the system shown in FIG. 1.

FIG. 3 is a flow diagram of an exemplary method provided an a syndicated information/ad mixer in accordance with one embodiment of the present invention.

FIGS. 4-6 show various alternative embodiments for implementing a system in accordance with the present invention.

FIG. 7 shows the elements of a computer system which can be used, depending on the modules and routines included therein, to implement any one of the system components used in the exemplary embodiment of FIG. 1.

FIG. 8 illustrates an exemplary syndicated feed, e.g., an RSS feed, that may be returned by a syndicated content provider system in response to a search request for the term “flowers”.

FIG. 9 illustrates an exemplary targeted ad that may be returned by a targeted ad server system in response to a search for the term “flowers”.

FIG. 10 illustrates an exemplary set of response information in a syndicated content format, e.g., the RSS format, generated in accordance with the invention by combining the search request results and the targeted ad information shown in FIGS. 8 and 9 prior to providing the results to a user of the system.

FIG. 11 illustrates an exemplary syndicated feed, e.g., an RSS web log, that may be returned by a syndicated content provider system in response to a search request for a particular web log.

FIG. 12 illustrates an exemplary targeted ad that may be returned by a targeted ad server system in response to a request for the particular web log shown in FIG. 11.

FIG. 13 illustrates an exemplary set of response information in a syndicated content format, e.g., the RSS format, generated in accordance with the present invention by combining the results and the targeted ad information shown in FIGS. 11 and 12 prior to providing the results to a user of the system.

FIG. 14 illustrates another exemplary syndicated feed, e.g., an RSS or Atom web log or list of search results that may be returned by a syndicated content provider system in response to a search request or request for a web log.

FIG. 15 illustrates first and second exemplary targeted ads that may be returned by a targeted ad server system in response to a request for the particular syndicated feed shown in FIG. 14.

FIG. 16 illustrates an exemplary set of response information in a syndicated content format, e.g., the RSS format or Atom format, generated in accordance with the present invention by combining the syndicated feed and the targeted ad information shown in FIGS. 14 and 15 prior to providing the results to a user of the system, e.g., as part of a syndicated content distribution process.

### DETAILED DESCRIPTION

The present invention is directed to automated methods and apparatus for incorporating targeted ads into information in a syndicated, e.g., RSS, content presentation format. The following description is presented to enable one skilled in the art to make and use the invention, and is provided in the context of particular applications and their requirements. Various modifications to the disclosed embodiments will be apparent to those skilled in the art, and the general principles set forth below may be applied to other embodiments and applications. Thus, the present invention is not intended to be limited to the embodiments shown and the inventor regards his invention as any patentable subject matter described.

Syndicated feeds are often supplied to a variety of parties. Embedding an advertisement directly into an original syndication feed can result in the advertisement not being well targeted to the viewer of the feed. Moreover, because syndicated feeds may be provided over extended periods of time, an advertisement embedded into the original syndication feed may be substantially out of date by the time it is viewed. Similarly, if ads compete with one another (e.g., for placement in the RSS feed) using offer information (e.g., bids, maximum price the advertiser is willing to pay, etc.) from advertisers' accounts or performance information (e.g. click-through rate or conversion rate), such information may be stale by the time the ad is rendered, selected, etc. For example, an advertiser may have reached a budget limit or closed their account. In addition, having the advertisement embedded into the original syndication feed complicates tracking and viewing of advertisements by end users, e.g., for advertisement billing purposes, for ad performance tracking purposes, etc.

Generally, it is undesirable from a cost and timeliness standpoint, to use hand classification, which involves a human being in the targeting and selection process, to target Internet advertisements. Unfortunately however, untargeted advertisements generally produce fewer desired responses than targeted advertisements, making them less attractive to advertisers and service providers since untargeted advertisements are likely to produce less revenue than targeted advertisements.

Accordingly, in the case of Internet advertising it is beneficial, from a revenue generation standpoint, that an advertisement be targeted to the end viewer and that the advertisement be current. In addition, it is desirable that the presentation of the advertisement can be tracked so that the advertiser can be charged on a per-presentation basis, and/or on the number of responses to a presented advertisement, e.g., based on ad selection, conversion, etc.

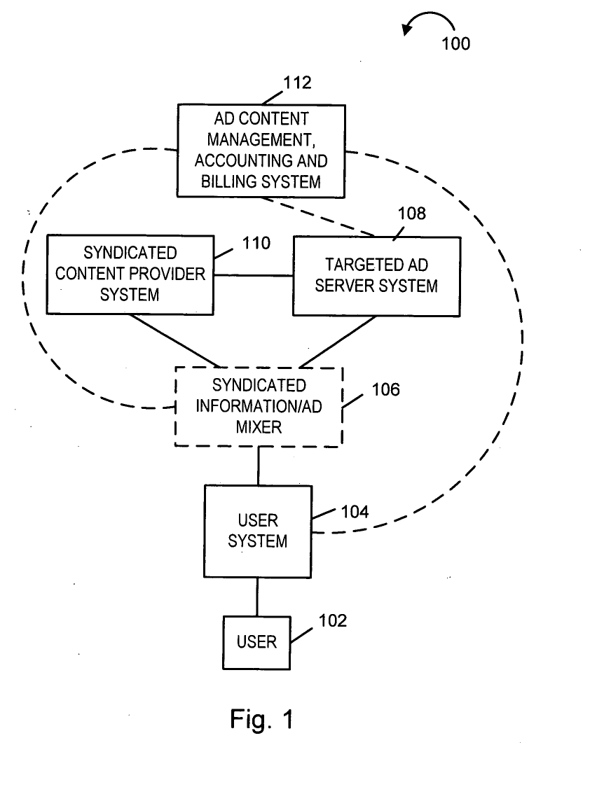

FIG. 1 illustrates a system 100 implemented in accordance with one exemplary embodiment of the present invention. The system 100 includes a user system 104, syndicated information/ad mixer 106, a syndicated content provider system 110, a targeted ad server system 108 and an ad content management, accounting and billing system 112 coupled together as shown in FIG. 1, e.g., via Internet or other network connections.

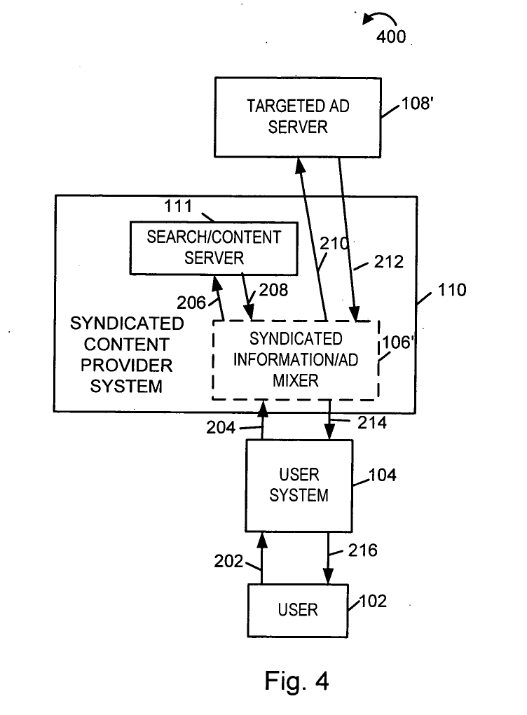

A user 102 interacts with the system 100 by way of the user system 104. The user system 104 is coupled in the FIG. 1 embodiment to the syndicated content provider system 110 and targeted ad server system 108 via the syndicated information/ad mixer 106. While shown in FIG. 1 as a separate entity, as will be discussed further with regard to FIGS. 4-6, the syndicated information/ad mixer 106 may be incorporated directly into any of the user system 104, syndicated content provider system 110 or targeted ad server system 108 rather than being implemented as a separate entity. Alternatively, operations of the syndicated information/ad mixer 106 may be distributed across more than one of the systems of 104, 108, 110.

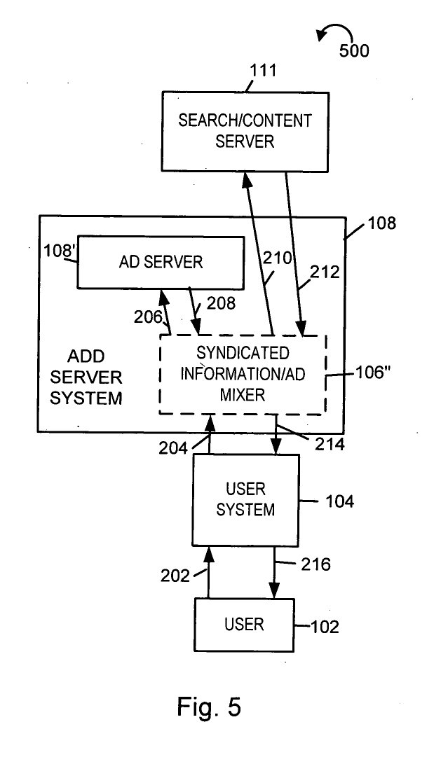

The user system 104 may be, e.g., a personal computer system including a Web browser application, a processor, memory and one or more input/output devices through which the user 102 interacts with the user system 104 and the other components of the communications system 100. One such exemplary system implementation is shown in FIG. 7 which is discussed below. Through a user input device of user system 104, the user 102 can initiate a search, transmit URL information seeking access to a particular site or otherwise initiate a syndicated information retrieval operation. These operations may be initiated using the Web browser or another application present on the user's system 104.

The syndicated content provider system 110 may include and/or be implemented as, a search engine and/or web content server. Thus, the syndicated content provider system 110 may, and sometimes does, include both a search engine and data base including syndicated content. Rather than include the syndicated content in a local database, the syndicated content provider system can, and in some embodiments does, access and retrieve remotely stored syndicated content for purposes of returning it in response to a user request. The syndicated content provider system 110 supplies requested information in a syndicated format to the syndicated information/ad mixer 106. In some embodiments, it also supplies content information, e.g., a portion of the information being returned to the mixer 106, to the targeted ad server system 108 for use in selecting a targeted ad. Targeted ad selection information, e.g., control information, may be supplied to the targeted ad server system on a per channel basis so that different ads can be selected for different channels using channel content or information indicative of channel content.

Targeted ad server system 108 may be implemented as, or include, a targeted ad server which uses content or keyword ad selection techniques to select and return one or more targeted ads to the syndicated information/ad mixer 106. In some embodiments one or more ads are returned for each channel in a retrieved or returned set of information with different ads being supplied for different channels. Targeted ad server system 108 normally includes a database of ads, an ad selection mechanism, e.g., an ad selection routine stored in memory and a processor for implementing the routine. In the case of keyword ad targeting techniques, an ad may be selected, e.g., using one or more words or phrases included in a user search request being processed by the syndicated content provider system. In the case of a content targeting technique, the ad is selected using at least a portion of the content being returned by the content provider system 110 or information, e.g., channel description, which is indicative of the content that will be returned to the user. For example, the targeted ad server system 108 may include information about the content corresponding to different URLs and thus, using the particular URL from the received from a user or the syndicated content provider system 110 can select an appropriate ad corresponding to the content that will be returned by the syndicated content provider system in response to receiving the particular URL.

Ad content management, accounting and billing system 112 is coupled to the targeted ad server system 108, syndicated information/ad mixer 106 and to the user system 104. The ad content management, accounting and billing system may be responsible for updating the content of ads which are stored in, and/or served by, the targeted ad server system. Ad updates may be initiated by advertising service subscribers or initiated in response to changes in advertising agreements, e.g., ads from the database of ads to be served may be deleted when a subscriber's advertising subscription terminates. The system 112 may also be responsible for keeping track of metrics used to bill for ads, e.g., the number of times an ad is served by the targeted ad server system 108, ad placement and/or the number of times a user clicks on or otherwise responds to a targeted ad presented to the user. Billing may also be a function of placement of an ad, e.g., the item number or channel, within the syndicated information returned by the syndicated information/ad mixer 106 of the present invention. Targeted ad server system 108, syndicated information/ad mixer 108 and/or user system 104 may provide information on the selection, presentation and/or positioning of selected ads for billing purposes to the ad content management and billing system 112. The user system 104 may, and in various embodiments does, also provide information on user response to a presented ad. Such information, relevant to billing, may be stored in an accounting database in system 112 and used to generate invoices which are sent to advertising service subscribers, e.g., on a monthly or other basis.

The syndicated information/ad mixer 106 is responsible for forwarding requests for syndicated content, e.g., a search request, web log title, or URL, from a user 102 to the syndicated content provider system 110 and/or the targeted ad server system 108. Such implementations may be particularly useful when ads are targeted on a per channel basis in a set of information including multiple channels. In some embodiments, syndicated content provider system 110, rather than the syndicated information/ad mixer, supplies the information used to target ads to the targeted ad server system 108. In addition, the syndicated information/ad mixer may combine syndicated content supplied by the syndicated content provider system, e.g., in a syndicated content format such as the RSS format, with one or more targeted ads provided by the targeted ad server system 108, to generate a set of response information in a syndicated format that includes the targeted ad. The set of response information may be returned to the user system 104 to be presented to the user 104, e.g., via a display device or other output device present at the user system 104. Given that the targeted ad is inserted in response to a user information request, e.g., search query, the inserted ad can be far more recent, e.g., current, than the syndicated information into which it is inserted prior to presentation to the user. Furthermore, insertion in this manner allows databases of ads and contracts regarding which ads are to be presented at any given time and the charge for presenting such ads to be updated and maintained independently of the management and updating of the syndicated content. Thus, while a web log or other syndicated information may age and be years old, the targeted ads presented to the user as part of the syndicated information provided in response to a user retrieval request, as well as ad information used to select and/or score the ad, can be kept current. Thus, the syndicated information may be older than the ad or ads inserted into the syndicated information. The age difference may be indicated by the ad having a more recent creation, edit or change date associated with the ad than a date of the same type associated with the syndicated information into which the ad is inserted. As will be discussed below, in some embodiments, targeted ads are inserted as items in a channel which already exists in the information returned by the syndicated content provider system 110. Thus, the information in syndicated format presented to the user 102 may include a list of discrete items, e.g., a channel or feed, returned as the results of a search or other information request, as well as the targeted ads selected by the targeted ad server system 108.

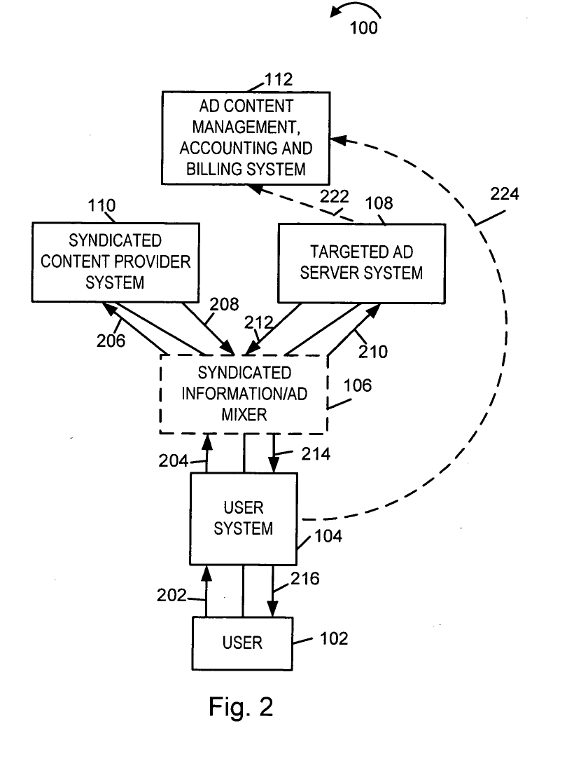

Having described the elements of the exemplary system 100, message and/or information passing steps performed in accordance with one exemplary embodiment of the present invention will now be described with reference to FIG. 2. In FIG. 2, arrows are used to illustrate passing a message or information between system elements. As shown in FIG. 2, user 102 may initiate retrieval of information in a syndicated format, e.g., the RSS format, by entering a keyword as part of a search or a web log identifier such as a URL. Arrow 202 represents entry of an information retrieval request into the user system 104. The user system 104 sends the retrieval request information to syndicated information/ad mixer 106 as represented by arrow 204. In addition, user profile and/or geographic location information may be conveyed to the mixer 106 from the user system 104 for use in ad targeting when user and/or geographic location ad targeting is used by the ad server system 108. The retrieval request is communicated by way of the syndicated information/ad mixer to both the syndicated content provider system 110 and the targeted ad server system 108 as indicated by arrows 206, 210.

The syndicated content provider system 110 responds to the received information requested by conducting a search and/or otherwise identifying the requested information, retrieves the information and then returns the requested information in a syndicated format to the syndicated information /ad mixer 106. The return, e.g., communication, of the retrieved information in a syndicated format to the mixer 106 is represented by arrow 208.

The targeted ad server system 108 uses information in the user request and/or information about the content of information being returned by the syndicated content provider system 110 in response to the user request, to select one or more targeted ads. In addition, or alternatively, the ad server system 108 may use user profile information and/or user location information to target ads. Thus, ads may be targeted based on keywords, syndicated content information, user profile information and/or user location information. The return of the selected targeted ad(s) to the syndicated information ad mixer 106 is represented by arrow 212.

In accordance with aspects of the present invention, the syndicated information/ad mixer 106 combines the targeted ad(s) returned by the targeted ad server system 108 with the information returned by the syndicated content provider system 110 to generate a set of response information in a syndicated format. Combining the ad with the information returned by the content provider system 110 normally involves including the ads as individual items within one or more channels which already exist in the returned syndicated information.

The generated set of response information is communicated, as represented by arrow 214, from the syndicated information/ad mixer 106 to an application within the user system 104, e.g., an application such as a Web browser which is used to display or otherwise present information in a syndicated content format to the user 102. Arrow 216 represents the presentation, e.g., displaying, of the returned set of response information, including both the responsive syndicated information and targeted ad(s), to the user 102.

In FIG. 2, dashed arrows 222 and 224 are used to represent the communication of statistics and/or other information used to track ad insertion, ad presentation and/or user response to presented ads. In the case of user response information, such information is normally conveyed by the user system 104 while other types of ad information may be conveyed by either the user system 104 or mixer 106. The conveyed information is used by the system 112 for accounting, billing and other purposes.

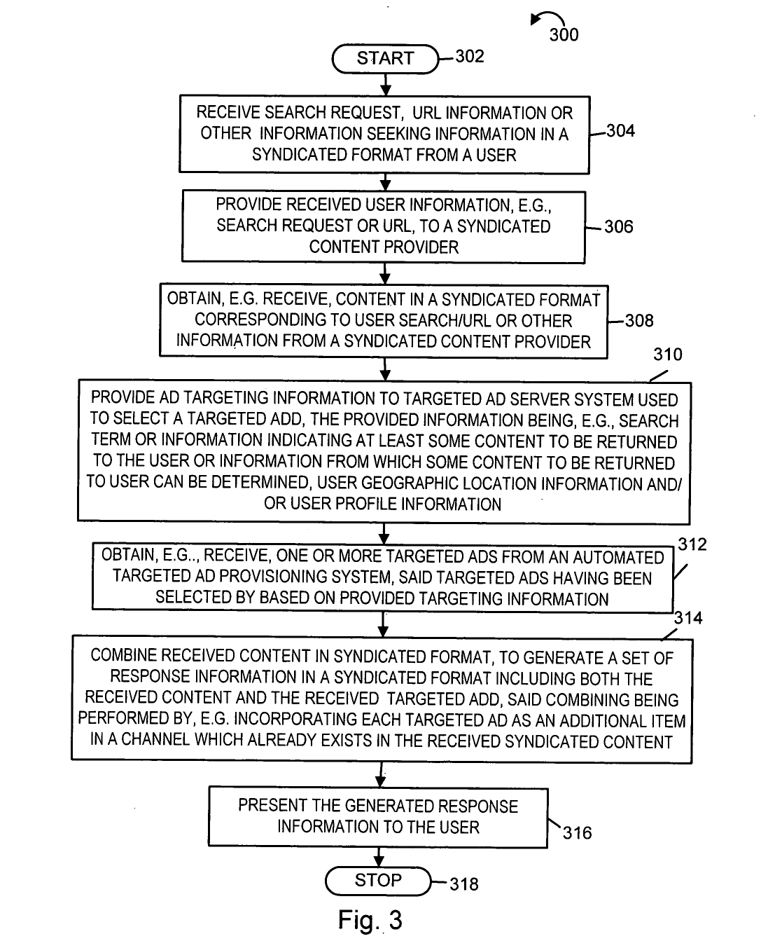

FIG. 3 is a flow diagram of an exemplary method of operating a syndicated information/ad mixer 106 to forward a search or other syndicated content retrieval and to generate a set of response information in a syndicated format which includes at least one targeted ad. Start node 302 marks the start of the method 300 with processing beginning in block 304. In block 304, the mixer 106 receives a search request, URL information, or other information seeking some content in a syndicated format. Note that mixer 106 may also receive other information useful in targeting advertisements, including information about a user such as a user profile, interests, geographical location, etc. Thus, the ad may be targeted based on user information, targeted based on a geographic location, targeted based on keywords or based on content. Accordingly user, geographic, keyword and content based ad targeting are contemplated and can be used to automatically select ads in accordance with the invention. In block 306, the mixer 106 provides the received information, e.g., search term, web log identifier or URL, to a syndicated content provider. Then, in block 308, the mixer 106 receives the requested content, e.g., search results or web log, in a syndicated format from the syndicated content provider system 110. In block 310, the mixer 106 may provide request and/or other ad targeting information, e.g., search term keywords, content information such as a URL, title or description included in the syndicated content, geographic location information indicating the geographic location of a user initiating a request of syndicated information and/or user profile information, as well as other received information to a targeted ad server system 108. Then in block 312, the mixer 106 receives one or more targeted ads from the targeted ad server system 108.

The targeted ad(s) received in step 312 may been selected from a plurality of ads by the ad server system 108 using the information supplied in step 310 and any one of a plurality of ad targeting techniques including, e.g., keyword ad targeting, content targeting, geographic location targeting and/or user targeting. In the case of keyword targeting a keyword from a user information request, e.g., search, and/or keyword included in the syndicated content to be returned to the user may be used to select an ad. In the case of content targeting information indicative of the content of the syndicated information to be returned to the user may be used to select an ad. The information indicative of the content may be a portion of the actual syndicated content such as a channel or item URL, title and/or description or portion thereof. In the case of geographic location targeting, the ad targeting may be based on geographic location information supplied by the user's system. This may result in, e.g., an ad for a retailer located in the geographic vicinity of the user making the syndicated content information retrieval request being selected as the targeted ad. User profile information, e.g., indicating hobbies, education level or other user information, provided by the user system 104, may be used for selecting user targeted ads.

While blocks 308 and 310 are shown being performed subsequent to blocks 304, 306 it is to be understood that blocks 304, 306 and 308, 310 can be performed in parallel. Next, in block 314, the mixer combines the received content in syndicated format with one or more received targeted ads. This normally involves inserting each received targeted ad as an item in one or more channels which are included in the received content which is in syndicated format. The resulting combination of responsive information and targeted ad(s) is a set of response information that is in a syndicated format. In block 316, the mixer 106 presents the generated response information to the user 102, e.g., by sending it to the user's system for display by the user system's web browser or another application. The method stops in block 318 pending processing another request for syndicated content form a user. While requests are shown passing through the mixer 106, it can be appreciated that the requests can be directly routed to the syndicated content provider system 110 and/or targeted ad server system 108 with the mixer 106 still serving as the element which combines the targeted ad(s) with the requested information.

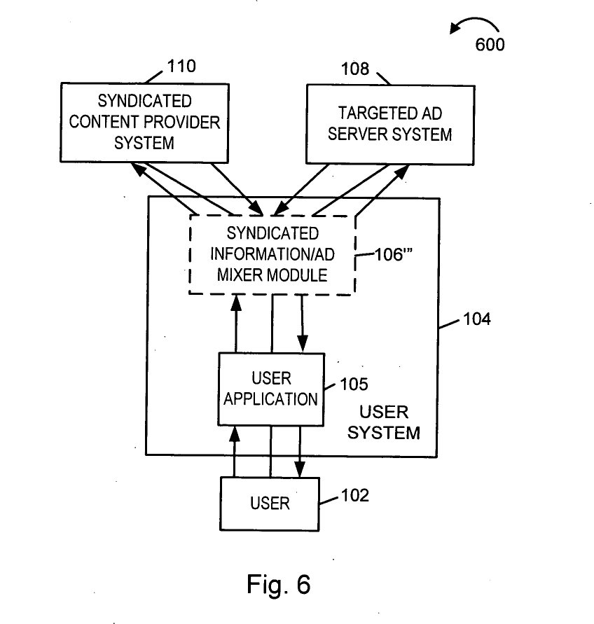

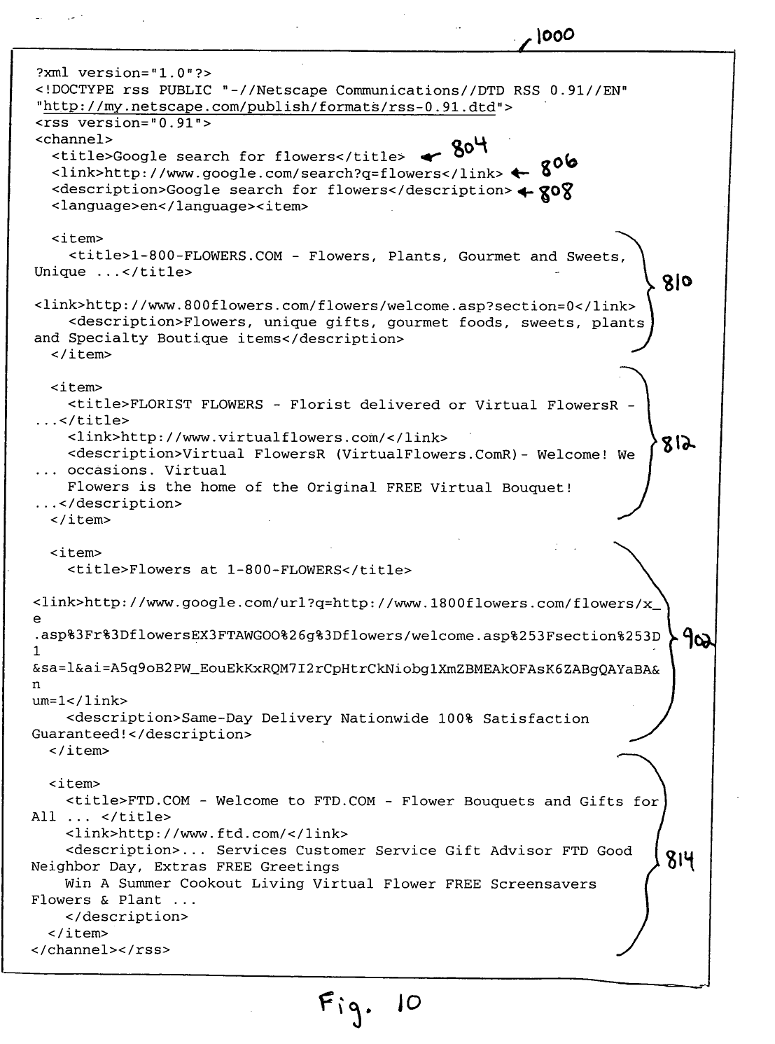

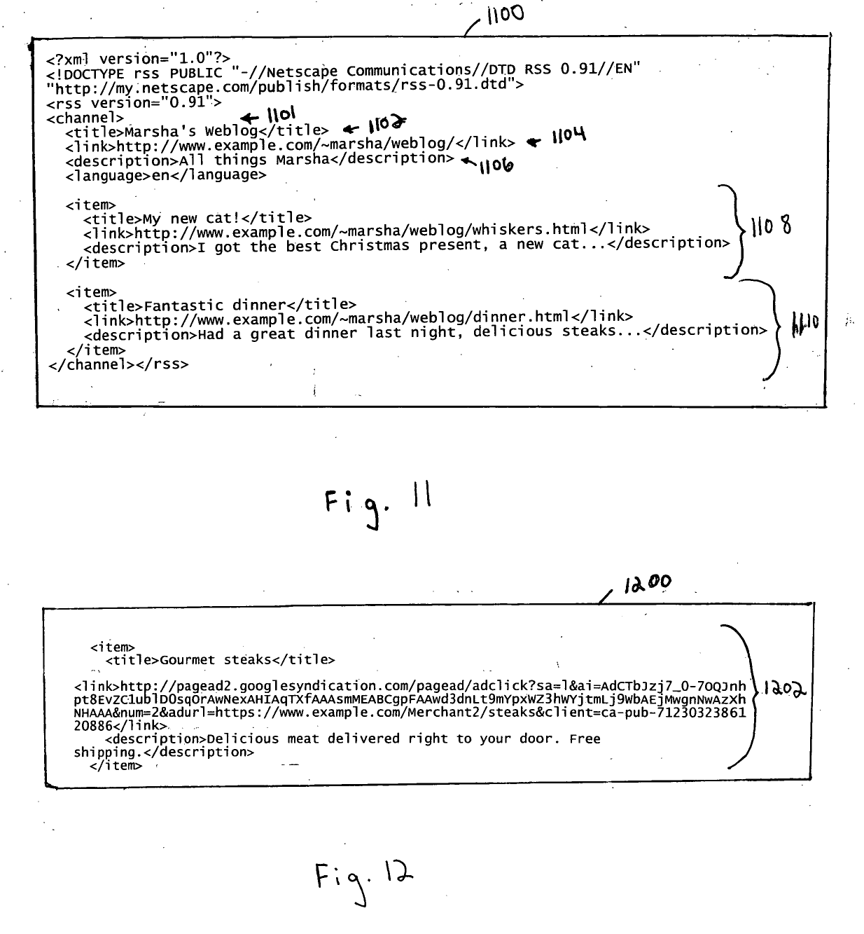

To better understand the operation of the syndicated information/ad mixer 106 of the present invention, reference will now be made to FIGS. 8-13. FIG. 8 illustrates an exemplary set of search results 802 in a syndicated format, e.g., the RSS format which is XML v1.0 compliant. The results 802 are returned by the syndicated content provider system 110 to the syndicated information/ad mixer 106 in response to an exemplary search for the word “flowers” requested by user 102. The search results include a single channel 803 having the channel title 804 “Google search for flowers”. The channel 803 includes a channel link 806 and a channel description 808. In addition channel 803 includes three items 810, 812, 814, each item having its own title, link and description.

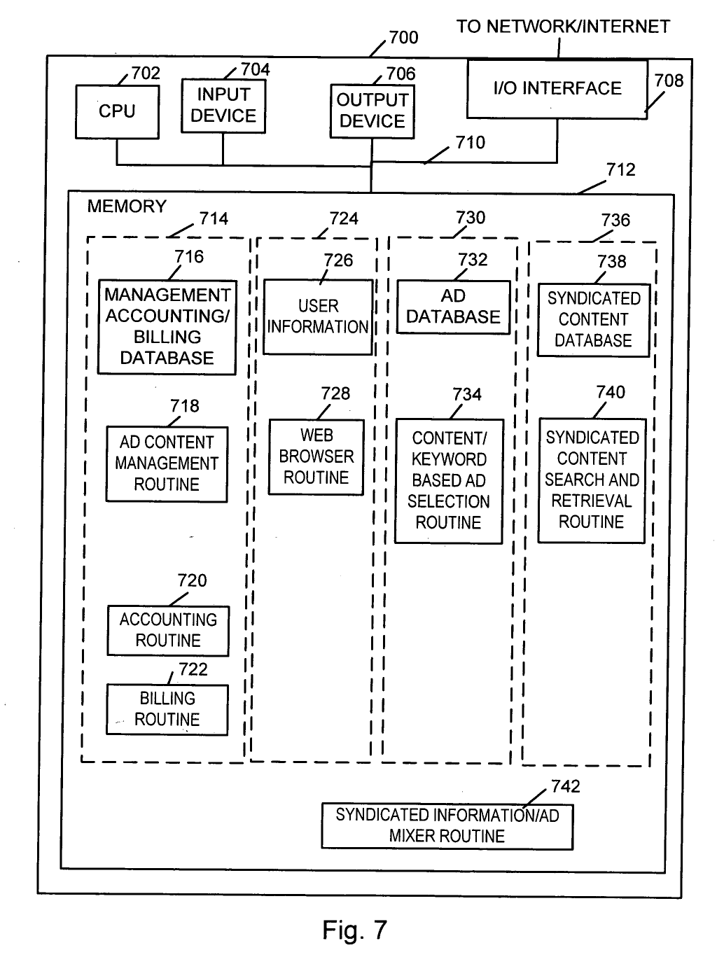

FIG. 9 illustrates an exemplary targeted ad 900 returned from the targeted ad server system 108 to the syndicated information/ad mixer 106 in response to the search request keyword “flowers”. The targeted ad 900 is formatted as an item to be included in a channel of a syndicated feed. While the ad 900 is provided by the targeted ad server 108 in a syndicated content format, in some embodiments, the syndicated information/ad mixer receives the ad information and processes it to put it into a syndicated content item format prior to combining it with the syndicated content received from the syndicated content provider system 110.

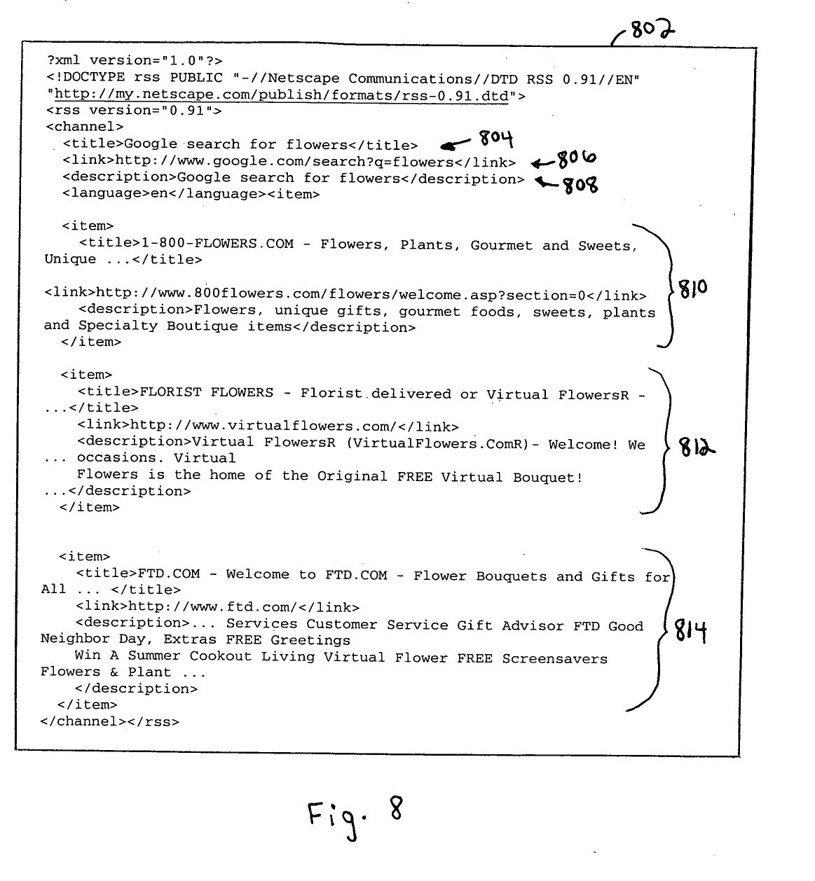

The syndicated information/ad mixer 106 combines the syndicated content 800 with the targeted ad 900. The results of this combination are shown in FIG. 10. The resulting response information 1000 includes the channel 803 and related information 804, 806, 808 which was present in the syndicated information 800. The targeted ad 900 is inserted as an item 902 into the set of search results so that the set of response information 1000 includes, as the third item in the channel, the ad item 902. In this manner, when the set of response information 1000 is presented to the user in the exemplary RSS format it includes the targeted ad 902. As discussed above, the targeted ad item 902 may be more (e.g., recent in terms of its creation date, etc.) than the other items 810, 812, 814 included in the RSS feed provided by the syndicated content provider system 110. While insertion of an ad into a single channel is shown, the operation is similar for the case of multiple channels.

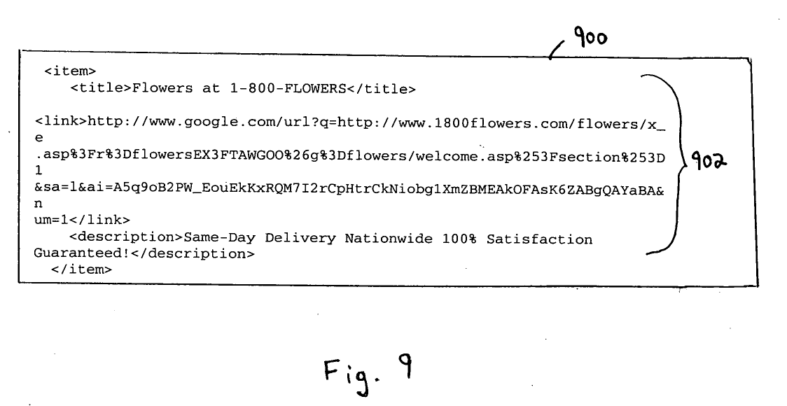

FIGS. 11-13 show an example of processing a web log 1100 in syndicated format and a targeted ad 1200 by syndicated information/ad mixer 106 to generate in a response set of information 1300 in syndicated format which is to be returned and presented to a user 102. The web log 1100 and targeted ad 1200 are provided by the syndicated content provider system 110 and targeted ad server system 108 in response to a user request to retrieve a web log titled “Marsha's Weblog”. The web log 1100 includes a single channel 1101, a channel title 1102, channel link 1106 and two items 1108, 1110. The targeted ad 1200 includes a single item. The responsive set of information 1300 in the RSS format includes the same information as the web log 1100 but also includes the targeted ad 1202 as an item of the already existing channel 1101. Thus, the web log retrieval results 1300 that will be presented to the user 102 incorporate the targeted ad that was added to the original web log 1100 in accordance with the present invention.

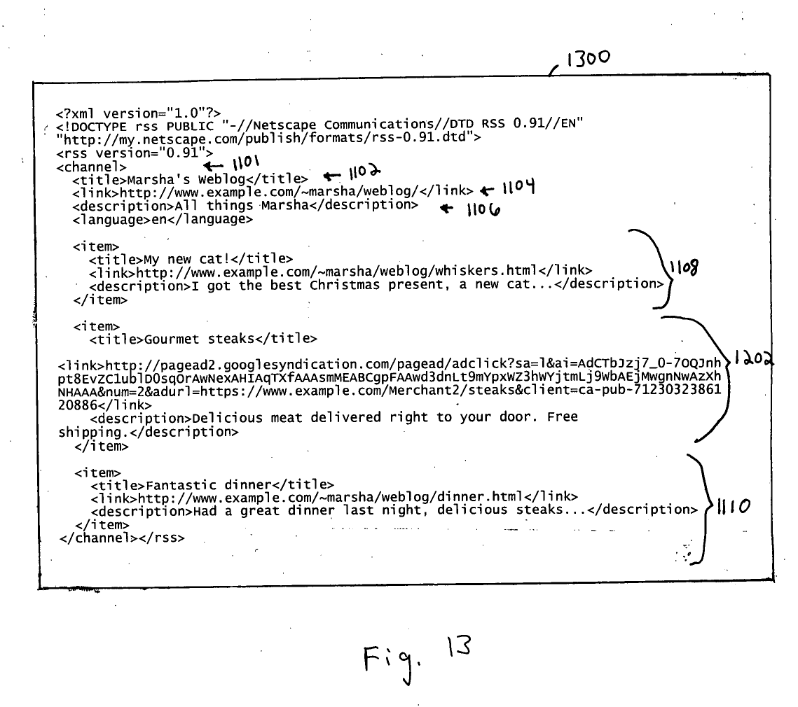

FIGS. 14-16 show an example of processing a set of information 1400 in syndicated content format and a set of targeted ads 1500, by syndicated information/ad mixer 106, to generate a response set of information 1600. The information 1600 is in syndicated format and is to be returned and presented to a user 102. In some embodiments the feed 1400 includes text and is devoid of page layout information. The absence of page layout information is common with syndicated feeds. In some embodiments, the syndicated feed returned by the content server system and the set of response information returned by the mixer 106 are intentionally kept free of page layout information.

The feed 1400 corresponds to a single channel 1401 which is identified by channel title 1402. A channel link 1404, e.g., URL, and channel description 1406 are also included in the syndicated feed 1400 along with a list of items that includes a first item 1408, second item 1410 and third item 1412. Included with each item 1408, 1410, 1412 is an item title, item link and item description.

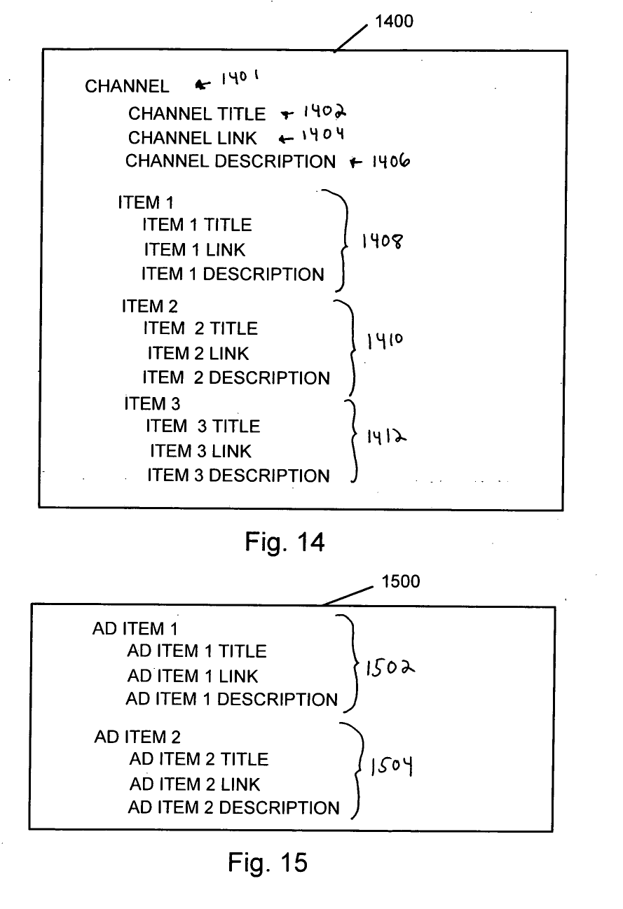

FIG. 15 illustrates first and second exemplary targeted ads that may be returned by a targeted ad server system 108 as a set of targeted ads 1500 in response to a request for the particular syndicated feed shown in FIG. 14. In accordance with the present invention targeted ads 1502, 1504 are presented in the format of items which are part of a syndicated feed to facilitate their insertion into the feed 1400. In various embodiments each of the items 1502, 1504 are selected as a function of different information indicative of the content of different items 1408, 1410 included in the feed 1400. The information used for targeting purposes may be the link (URL), title, and/or description information included in items 1408, 1410. In this manner, ads can be targeted to the content of individual items in a feed. In the case where different keywords result in different items being included in the feed 1400, the different ads maybe targeted based on the different keywords. Thus, a first keyword may be used to target an ad corresponding to the first item 1408 and a second ad can be used to target an ad corresponding to the second item 1410.

In some embodiments when multiple ads are returned by the targeted ad server system 108, the targeted ad corresponding to a particular item of the syndicated feed received by the mixer 106 is normally inserted immediately before or after the particular corresponding item when generating the response set of information, e.g., the response set of information 1600.

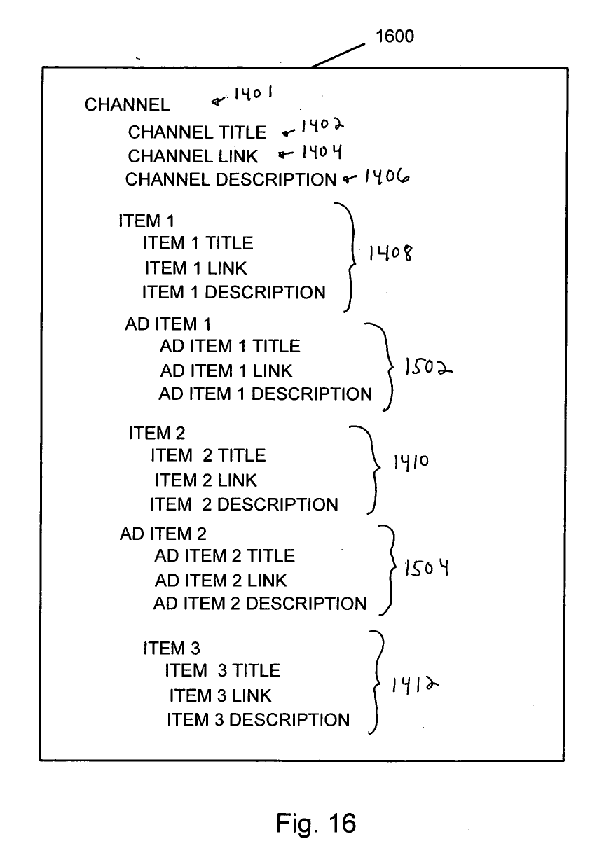

FIG. 16 illustrates an exemplary set of response information in a syndicated content format, e.g., the RSS format or Atom format, generated in accordance with the present invention by combining the results and the targeted ad information shown in FIGS. 14 and 15 prior to providing the results to a user of the system, e.g., as part of a syndicated content distribution process. In the example of FIG. 16, the first targeted ad item 1502 was selected based on content and/or keyword information corresponding to syndicated content information item 1 1408. In the example, it is therefore inserted immediately following the first syndicated content item 1408 in the set of response information 1600. The second targeted ad item 1504 was selected based on content and/or keyword information corresponding to syndicated content information item 2 1410. It is therefore inserted immediately following the second syndicated content item 14010 in the set of response information 1600.

As discussed above, the syndicated information/ad mixer 106 of the present invention can be incorporated into any one of the syndicated content provider system 110, targeted ad server system 108 and user system 104 and need not be implemented as a standalone system. FIGS. 4-6 show various possible implementations where the mixer 106 is incorporated into another device. Numbered arrows, bearing the same reference numbers as shown in FIG. 2, correspond to the same or similar message passing steps previously described with regard to FIG. 2.

In the FIG. 4 example, the syndicated information/ad mixer is incorporated as a module 106′ directly into the syndicated content provider system 110 which, in addition to the mixer 106′ includes a search content server 111. The search content server 111 provides the user requested syndicated content while targeted ad server 108′ supplies the targeted ad(s) to be combined with the content supplied by search/content server 111.

In the FIG. 5 example, the syndicated information/ad mixer is incorporated as a module 106″ directly into the targeted ad server system 108 which, in addition to the mixer 106″, includes a targeted ad server 108′. The targeted ad server 108′ provides the targeted ad(s) to be combined with the content supplied by search/content server 111.

In the FIG. 6 example, the syndicated information/ad mixer is incorporated as a module 106′″ directly into the user system 104 which, in addition to the mixer module 106′″ includes a user application 105 such as a web browser. The web browser is responsible for receiving user requests for syndicated information, passing the requests to the mixer module 106′″ and for providing the returned results to the user 102, e.g., by displaying the response information which includes the content information supplied by syndicated content provider system 110 and the targeted ad(s).

Notably, in each of the embodiments of FIGS. 4-6, the syndicated information/ad mixer module is responsible for receiving syndicated content requested by the user and at least one targeted ad to generate the response information, including a targeted ad,

FIG. 7 illustrates a system 700 which can be used as any one of the various systems 110, 108, 104 shown in FIG. 1. Depending on the use of the system 700, the system may include different applications and/or databases to provide the functionality required for a particular use. As illustrated the system 700 includes a processor, e.g., CPU, 702, input device 704, output device 706, Input/Output (I/O) interface 708 and memory 712 which are coupled together by a bus or network 710. The input device may be, e.g., a keyboard, while the output device maybe, e.g., a display or printer. The I/O interface may be used to couple the system 700 to other device and/or systems via, e.g., a network or the Internet.

The memory 712 includes various routines and databases depending on the intended use of the exemplary system 700. The routines are executed by the CPU 702 and control the operation of the system 700. In one exemplary embodiment, when used as an ad content management, accounting, and billing system 112, the system 700 includes the elements in memory block 714, i.e., a management, accounting and billing database 716, an ad content management routine 718, an accounting routine 720 and a billing routine 722. The management, accounting and billing database 716 includes information about ad management, information used to track ad presentation and/or user responses to ads, and/or billing information regarding charges incurred by advertisers. Ad content management routine 718 is used to control the updating of ads, e.g., ads stored in the targeted ad server system. Ads may be updated as advertising agreements change or advertisers seek to update the content of an ad. Accounting routine 720 processes ad serving and user response information thereby generating information that can be used for billing purposes. Billing routine 722 is responsible for generating bills based on the accounting information generated as part of the ad presentation and user response tracking process.

When configured to be used as a user system 104, the system 700 may include the elements in memory block 724. These may include, for example, a set of user information 726, e.g., user profile information, passwords, information on the geographic location of the user, etc. In addition memory block 724 may include a Web Browser 728 or other user application capable of receiving user input, processing the input to generate requests for syndicated information which are sent to another device for retrieval purposes, and to control the presentation of returned syndicated material to the user of the system 700.

When configured to be used as a targeted ad server system 108, the system 700 may include the elements in memory block 730. These may include an ad database 732 and a content and/or keyword-based ad selection routine 734. When executed, the routine 734 may operate in an automated manner to select an ad from the database 732 using keyword or content targeting selection techniques. The targeted ad selection process may occur in an automatic fashion without the need for a human operator to be involved in the ad selection process.

When configured to be used as a syndicated content provider system 110, the system 700 may include the elements in memory block 736. These include a syndicated content database 738 and a syndicated content search and retrieval routine 740. The syndicated content database 738 may include a variety of information, e.g., news feeds, web logs, etc which are stored in a syndicated format, e.g., the RSS format or another XML v1.0 compliant format. The syndicated content search and retrieval routine 740 is responsible for processing information regarding a user initiated search or other information retrieval request to retrieve the information from the syndicated content database 738 that is being sought by the user.

When configured to be used as a stand alone syndicated information/ad mixer 106, the system 700 may include in memory a syndicated information/ad mixer routine that is used to control the forwarding of information retrieval requests to other systems and for combining retrieved information in a syndicated format with one or more targeted ads to generate a set of response information in a syndicated format that includes both the responsive syndicated content and one or more targeted ads. The routine 742 is also responsible for forwarding the generated set of response information to a device or module that is then responsible for presenting the information including the targeted ad(s) to the user.

As discussed above, syndicated information/ad mixer functionality is incorporated into the syndicated content provider system 110, targeted ad server system 108 and user system 104 in some embodiments. In such embodiments, the system which includes the mixer functionality includes the syndicated information/ad mixer routine 742 which provides the system 700 with such functionality.

While described in the context of various exemplary systems it should be appreciated that the methods and apparatus of the present invention are applicable to a wide range of systems and syndicated information formats. For example, although exemplary embodiments of the present invention are described in the context of a syndicated format complaint with XML v 1.0, it can be used with other syndicated formats.

1. A method of generating information including targeted ads, the method comprising:
receiving information in a syndicated format;
receiving a first targeted ad from an automated ad server system;
combining the first targeted ad with the received information to generate a set of response information which is also in a syndicated format.

2. The method of claim 1, wherein said syndicated format is a format for listing items corresponding to a channel, said received information including a listing of at least two items and including for each item, a title and a link.

3. The method of claim 2, wherein said received information further includes a channel title and a channel link.

4. The method of claim 2, wherein said syndicated format is an XML compliant format.

5. The method of claim 2, wherein said syndicated format is RSS.

6. The method of claim 2, wherein said syndicated format is Atom.

7. The method of claim 2, wherein the first targeted ad is included as an item in said received information, said item including an item title, an item link and an item description.

8. The method of claim 2, wherein said received information further includes, for each item of said listing a description.

9. The method of claim 8, wherein said received information further includes a channel title and a channel link.

10. The method of claim 9, wherein said received information further includes a channel description.

11. The method of claim 1, further comprising:
communicating keyword information to said automated ad server system to be used in selecting said first targeted ad from a plurality of ads.

12. The method of claim 11, wherein said first targeted ad is a keyword targeted ad that is targeted based on a keyword included in one of a user request for syndicated content and said received information in a syndicated format, said keyword being included in the communicated keyword information.

13. The method of claim 11, wherein said keyword is one of a user search term and a keyword included in said received information in a syndicated format.

14. The method of claim 13, further comprising:
operating said automated ad server system to select a first targeted ad from said plurality of ads as a function of said keyword information; and
operating said automated ad server system to communicate said first targeted ad to a syndicated content and ad mixer which performs said step of receiving information in a syndicated format and said combining step.

15. The method of claim 1, further comprising:
communicating syndicated content indicator information to said automated ad server system to be used in selecting said first targeted ad from a plurality of ads, said content indicator information being indicative of at least some content included in said received information in a syndicated format.

16. The method of claim 15, wherein said syndicated content indication information includes at least one of a title, a URL, and a portion of a description included in said received information.

17. The method of claim 1, where said first targeted ad is a content targeted ad that is targeted using syndicated content included in said received information in a syndicated format.

18. The method of claim 1, wherein syndicated content used to select said first targeted ad includes one of item description information, an item URL, and an item title included in said received information in a syndicated format.

19. The method of claim 1, further comprising:
communicating at least some user profile information to said automated ad server system to be used in selecting said first targeted ad from a plurality of ads.

20. The method of claim 19, wherein said first targeted ad is a user targeted ad, targeted based on user profile information.

21. The method of claim 1, further comprising:
communicating at least some geographic location information to said automated ad server system to be used in selecting said first targeted ad from a plurality of ads.

22. The method of claim 1, wherein said first targeted ad is a geographic location targeted ad, targeted based on the geographic location to which said received information in a syndicated format is to be delivered.

23. The method of claim 1, wherein said received information includes multiple items, the method further comprising:
receiving at least one additional targeted ad, said additional targeted ad being targeted to content of a different item from said first targeted ad; and
incorporating said at least one additional targeted ad into said received information so that the generated set of response information includes the received first targeted ad and said at least one additional targeted ad as items in the generated set of response information.

24. The method of claim 23, wherein item description information corresponding to a first item included in said received information in a syndicated format is used to determine the content of said first item for ad targeting purposes.

25. The method of claim 23, wherein a URL corresponding to a first item included in said received information in a syndicated format is used to determine the content of said first item for ad targeting purposes.

26. The method of claim 23, wherein the first targeted ad and the second targeted ad are incorporated into a channel which already exists in said received information.

27. The method of claim 26, wherein said received information and said generated set of response information include a single channel, said single channel of said received information and said generated set of response information having the same channel title, channel link and channel description.

28. The method of claim 26, further comprising, prior to receiving said first targeted ad and said additional targeted ad, communicating information indicative of the content of first and second items included in the received information in a syndicated format to a targeted ad server system which selects said first targeted ad and said additional targeted ad using an automated ad selection process.

29. The method of claim 28, wherein items in said received information are in a list of items, combining the first targeted ad with said received information including inserting the first targeted ad into the received information at a location within said list which is proceeding or subsequent said first item.

30. The method of claim 29, wherein incorporating said at least one additional targeted ad into said received information includes inserting the first targeted ad into the received information at a location within said list which is proceeding or subsequent said second item.

31. The method of claim 28, wherein said first targeted ad is selected as a function of a first URL corresponding to a first item included in said received information and said additional targeted ad is selected as a function of a second URL corresponding to the second item, the first and second targeted ads being different.

32. The method of claim 31, wherein said first targeted ad is selected as a function of a first keyword corresponding to a first item included in said received information and said additional targeted ad is selected as a function of a second keyword corresponding to the second item, the first and second targeted ads being different.

33. The method of claim 1 wherein combining the first targeted ad with the received information includes:
adding the first targeted ad as an individual item within said received information.

34. The method of claim 33, wherein adding the first targeted ad as an individual item of said received information includes:
incorporating the first targeted ad as an item within a channel which already exists within the received information.

35. The method of claim 1, wherein the first targeted ad includes content which is newer than the most recent content included in said received information.

36. The method of claim 1, wherein the first targeted ad has a more recent edit date than any edit date associated with said received information.

37. The method of claim 1, wherein the first targeted ad has a more recent change date than any change

38. A method of generating information and at least one targeted ad in a syndicated content format for presentation to a user, the syndicated content format, the method comprising:
receiving an feed responsive to a user request, said feed including a list of items, said list including for each item in the list a title and a URL;
receiving at least one targeted ad selected using an automated selection technique to be presented to said user with said RSS feed; and
combining the responsive feed and the at least one targeted ad to generate a set of response information in said syndicated content format.

39. The method of claim 38, wherein said syndicated content format is one of RSS and Atom.

40. The method of claim 38, wherein the responsive feed includes at least one channel, and wherein the act of combining the responsive feed and at least one targeted ad includes:
incorporating the at least one targeted ad into the feed as an item in said at least one channel.

41. The method of claim 40, further comprising:
operating a search engine to retrieve said received feed by searching for syndicated content responsive to a user search request and to send said feed to a mixer device which performs said receiving and combining.

42. The method of claim 40, further comprising:
operating a targeted ad server to select said at least one targeted ad as a function of i) at least one of keyword included in said user request; ii) information indicative of said feed including syndicated content; iii user profile information; and geographic location information.

43. The method of claim 42, wherein said targeted ad server selects at least one targeted ad for each of a plurality of items included in said feed, the ad selected for at least two different items being different.

44. The method of claim 43, wherein the responsive feed includes multiple items, the step of combining the responsive feed and at least one targeted ad includes:
incorporating at least one targeted ad between two items included in said responsive feed.

45. The method of claim 44, wherein different targeted ads are selected as a function of the content of the different items included in said responsive feed.

46. The method of claim 45, wherein each different targeted ad is inserted into said responsive feed immediately preceding or subsequent of the item whose content was used in selecting the particular targeted ad.

47. A system for generating information including targeted ads, the method comprising:
a syndicated information and ad mixer including:
means for receiving information in a syndicated format;
means for receiving a first targeted ad from an automated ad server system; and
means for combining the first targeted ad with the received information to generate a set of response information which is also in a syndicated content format.

48. The system of claim 47, wherein said syndicated format is a format for listing items corresponding to a channel, said received information including a listing of at least two items and including for each item, a title and a link.

49. The system of claim 48, further comprising a targeted ad server coupled to said syndicated information and ad mixer for selecting said targeted ad as a function of information indicating the content of said information in said syndicated content format.

50. The system of claim 49, wherein said information indicating the content of the information in said syndicated content format is at least one of a URL and a portion of a title included in said information in said information in said syndicated content format.

51. The system of claim 48, further comprising a targeted ad server coupled to said syndicated information and ad mixer for selecting said targeted ad as a function of user profile information corresponding to a user to whom said information in a syndicated content format is to be provided.

52. The system of claim 48, further comprising a targeted ad server coupled to said syndicated information and ad mixer for selecting said targeted ad as a function of geographic information indicating the geographic location of a user to whom said information in a syndicated content is to be provided.

53. The system of claim 48, further comprising:
a search engine coupled to said syndicated information and ad mixer for performing a search in response to a user request for syndicated information and for communicating the results of said search to said syndicated information and ad mixer.

54. The system of claim 53, further comprising:
a targeted ad server coupled to said syndicated information and ad mixer for selecting said targeted ad as a function of information indicating the content of said information in said syndicated content format; and
an accounting system coupled to said targeted ad server for keeping track of statistics used for billing for ads served by said targeted ad server system.

55. The system of claim 47, wherein said syndicated content format is one of RSS and Atom.
